(19) United States
(12) Patent Application Publication
(10) Pub. No.: US 2018/0252303 A1
(43) Pub. Date: Sep. 6, 2018

(54) Continuously Variable Drive Having A Ball-Type Continuously Variable Transmission

(71) Applicants: Dana Limited, Maumee, OH (US); FCA us LLC, Auburn Hills, MI (US)

(72) Inventors: Berthold Martin, Auburn Hills, MI (US); Travis J. Miller, Cedar Park, TX (US); Sebastian J. Peters, Cedar Park, TX (US)

(21) Appl. No.: 15/897,283

(22) Filed: Feb. 15, 2018

Related U.S. Application Data
(60) Provisional application No. 62/465,387, filed on Mar. 1, 2017.

(51) Int. Cl. F16H 37/02; F16H 3/66; F16H 15/50

(52) U.S. Cl. CPC F16H 37/022; F16H 3/66; F16H 15/503; F16H 2200/2043; F16H 2200/0043; F16H 2200/201; F16H 2037/023

(57) ABSTRACT

A device for the transmission of power in motor vehicles. Power is transmitted in a smoother and more efficient manner by splitting torque into two or more torque paths. In some embodiments, a continuously variable drive is configured to have a ball-type variator and two planetary gear sets. Clutches selectively engage members of the variator to provide multiple modes of operation.

### RELATED APPLICATION

The present application claims the benefit of U.S. Provisional Application No. 62/465,387 filed on Mar. 1, 2017, which is incorporated herein by reference in its entirety.

### BACKGROUND

Continuously variable transmissions (CVT) and transmissions that are substantially continuously variable are increasingly gaining acceptance in various applications. A driveline including a CVT allows an operator or a control system to vary a drive ratio in a stepless manner, permitting a power source to operate at its most advantageous rotational speed. The range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios.

The different transmission configurations could for example, multiply input torque across the different transmission stages in different manners to achieve the same final drive ratio. However, some configurations provide more flexibility or better efficiency than other configurations providing the same final drive ratio.

### SUMMARY

Provided herein is a continuously variable drive (CVD) including a variator having a first plurality of balls, each ball provided with a tiltable axis of rotation, each ball in contact with a first traction ring assembly and a second traction ring assembly, and each ball operably coupled to a carrier assembly. The CVD further includes a first planetary gear set arranged coaxially with the variator having a first ring gear operably coupled to the first traction ring assembly, a first planet carrier operably coupled to an input shaft, and a first sun gear operably coupled to the second traction ring assembly. The CVD further includes a multiple speed gear box coupled to the second traction ring assembly and the first sun gear. The multiple speed gear box includes a second planetary gear set arranged coaxially with the variator, the second planetary gear set having a second ring gear, a second planet carrier, and a second sun gear. The multiple speed gear box further includes a third planetary gear set arranged coaxially with the variator having a third ring gear operably coupled to the second planet carrier, a third planet carrier operably coupled to the second ring gear, and a third sun gear. The multiple speed gear box further includes a forward mode clutch operably coupled to the second traction ring assembly configured to selectively couple the second traction ring assembly to the third sun gear; a first-and-reverse mode clutch operably coupled to the third ring gear configured to selectively couple the third ring gear to ground; a second-and-fourth mode clutch operably coupled to the second sun gear configured to selectively couple the second sun gear to ground; and a third-and-fourth mode clutch operably coupled to the second traction ring assembly configured to selectively couple the second traction ring assembly to the second planet carrier.

In some embodiments, the continuously variable drive further includes a reverse mode clutch operably coupled to the second traction ring assembly and configured to selectively couple the second traction ring assembly to the second sun gear.

In some embodiments, the continuously variable drive further includes a torque converter coupled to the input shaft.

In some embodiments, the continuously variable drive further includes a locking clutch configured to selectively couple the first ring gear and the first planet carrier.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the ball-type variator of FIG. 1.

FIG. 3 is an illustrative view of different tilt positions of the ball-type variator of FIG. 1.

FIG. 4 is a schematic of a multiple mode continuously variable drive (CVD) having a ball-type variator.

FIG. 5 is a schematic of a multiple mode continuously variable drive (CVD) having a ball-type variator.

FIG. 6 is a table depicting operating modes of the CVD of FIG. 4.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiment. Furthermore, the embodiments include several novel features, no single one of which is solely responsible for its desirable attributes or which is essential to practicing the inventions described.

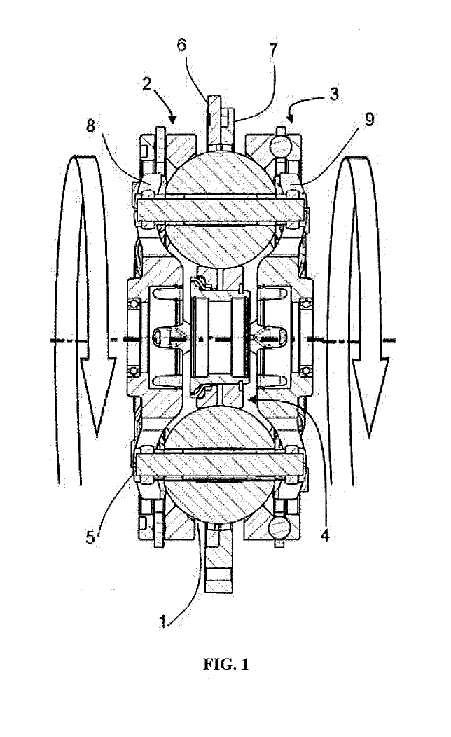

Provided herein are configurations of CVTs based on a ball-type variator, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, an input (first) 2 and output (second) 3, and an idler (sun) assembly 4 as shown on FIG. 1. Sometimes, the input ring 2 is referred to in illustrations and referred to in text by the label “R1”. The output ring is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7. Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa.

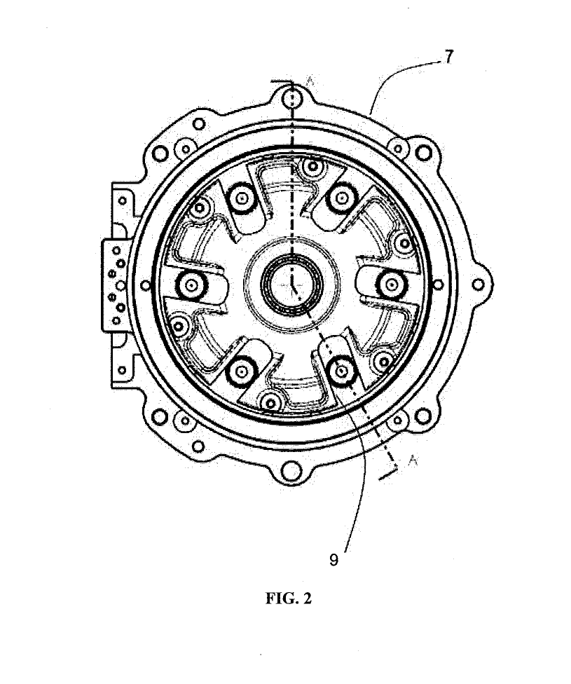

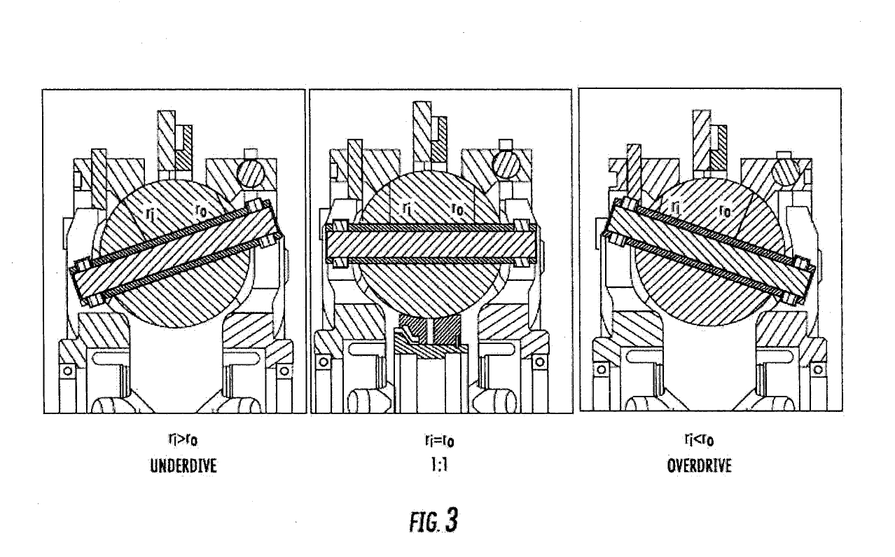

In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 9 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different. The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The embodiments disclosed herein are related to a CVT using generally spherical planets each having a tillable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in an embodiment where a CVT is used for a bicycle application, the CVT operates at times as a friction drive and at other times as a traction drive, depending on the torque and speed conditions present during operation.

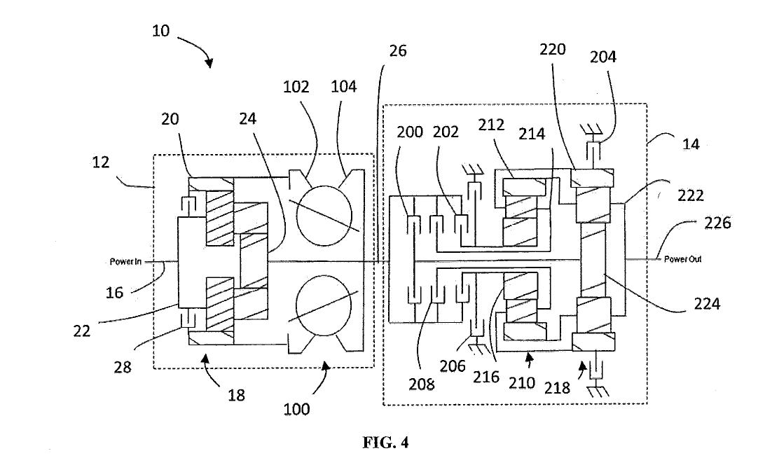

Referring now to FIG. 4, in some embodiments, a continuously variable drive (CVD) 10 includes a continuously variable device 12 operably coupled to a multiple speed gear box 14. The CVD 10 includes a first rotatable or input shaft 16 adapted to couple to a source of rotational power (not shown). The continuously variable device 12 includes a variator 100 having a first traction ring assembly 102 and a second traction ring assembly 104.

In some embodiments, the variator 100 is configured such as the variator depicted in FIGS. 1-3. The continuously variable device 12 includes a first planetary gear set 18 having a first ring gear 20, a first planet carrier 22, and a first sun gear 24. The first planetary gear set 18 is sometimes referred to herein as “the input split planetary gear set” having a ring to sun ratio represented by the term “RTS”. The first ring gear 20 is operably coupled to the first traction ring assembly 102. The first planet carrier 22 is operably coupled to the first rotatable shaft 16. The first sun gear 24 is operably coupled to the second traction ring assembly 104. In some embodiments, the first sun gear 24 is operably coupled to a second rotatable shaft 26. The second rotatable shaft 26 is configured to couple to the multiple speed gear box 14.

In some embodiments, the continuously variable device 12 is provided with a locking clutch 28 adapted to selectively couple the first ring gear 20 and the first planet carrier 22 to provide bypass of the variator 100 during operation. In some embodiments, the locking clutch 28 is optionally configured as a wet clutch, a one-way clutch, a synchronous clutch, or a mechanical diode.

In some embodiments, the multiple speed gear box 14 is provided with a number of clutching devices including a forward mode clutch 200, a reverse mode clutch 202, a first-and-reverse mode clutch 204, a second-and-fourth mode clutch 206, and a third-and-fourth mode clutch 208.

In some embodiments, the multiple speed gear box 14 includes a second planetary gear set 210. The second planetary gear set 210 has a second ring gear 212, a second planet carrier 214, and a second sun gear 216. In some embodiments, the second sun gear 216 is coupled to the second-and-fourth mode clutch 206 and the reverse mode clutch 202. The second-and-fourth mode clutch 206 is configured to selectively couple the second sun gear 216 to a grounded member. The second planet carrier 214 is coupled to the third-and-fourth mode clutch 208. The third-and-fourth mode clutch 208 is configured to selectively couple the second planet carrier 214 to the second traction ring assembly 104.

In some embodiments, the multiple speed gear box 14 includes a third planetary gear set 218 having a third ring gear 220, a third planet carrier 222, and a third sun gear 224. The third sun gear 224 is coupled to the forward mode clutch 200. The forward mode clutch 200 is configured to selectively couple the second traction ring assembly 104 to the third sun gear 224. The third ring gear 220 is coupled to the first-and-reverse mode clutch 204. The first-and-reverse mode clutch 204 is configured to selectively couple the third ring gear 220 to a grounded member. The second ring gear 212 is operably coupled to the third planet carrier 222. The third planet carrier 222 is adapted to couple to an output drive shaft 226. The output drive shaft 226 is adapted to transmit an output power from the CVD 10 through the multiple speed gear box 14.

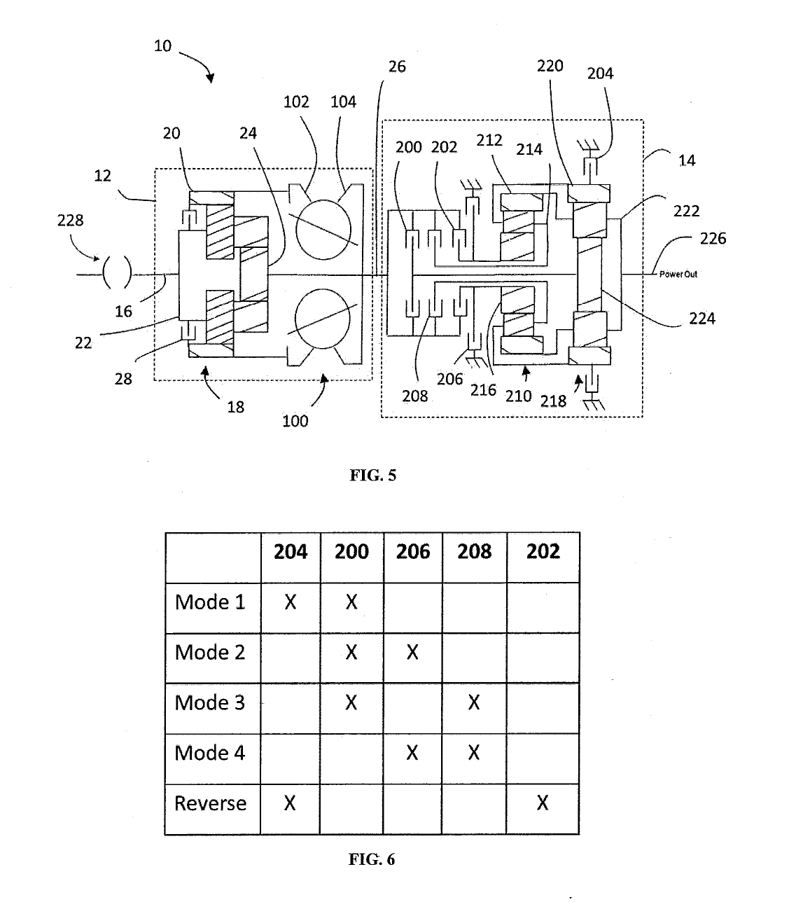

Referring now to FIG. 5, in some embodiments, the CVD includes a torque converter 228 coupled to the input shaft 16. The torque converter 228 couples the input shaft 16 to a rotating source of power (not shown) including, but not limited to, an internal combustion engine (diesel, gasoline, hydrogen) or any powerplant such as a fuel cell system, or any hydraulic/pneumatic powerplant like an air-hybrid system.

It should be appreciated that the configurations disclosed herein are optionally configured with other types of selectable torque transmitting devices including, and not limited to, wet clutches, dry clutches, dog clutches, and electromagnetic clutches, among others.

Referring now to FIG. 6, during operation of the CVD 10 multiple modes of operation are achieved through engagement of the various clutching devices to provide modes corresponding to overlapping ranges of speed and torque. Typically, the first mode of operation corresponds to a launch mode of a vehicle from a stop. The subsequent modes engaged correspond to higher speed ranges. Likewise, the reverse mode of operation corresponds to a reverse direction of a vehicle equipped with the CVD 10.

The table depicted in FIG. 6, lists the modes of operation for the CVD 10 and indicates with an “x” the corresponding clutch engagement or clutch position. For a first mode of operation (mode 1), the forward mode clutch 200 and the first-and-reverse mode clutch 204 are engaged. For a second mode of operation (mode 2), the forward mode clutch 200 and the second-and-fourth mode clutch 206 are engaged. For a third mode of operation (mode 3), the forward mode clutch 200 and the third-and-fourth mode clutch 208 are engaged. For a fourth mode of operation (mode 4), the second-and-fourth mode clutch 206 and the third-and-fourth mode clutch 208 are engaged. For a reverse mode of operation, the first-and-reverse mode clutch 204 and the reverse mode clutch 202 are engaged.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein are capable of being employed in practicing the invention. It is intended that the following claims define the scope of the invention and that methods and structures within the scope of these claims and their equivalents be covered thereby.

What is claimed is:

1. A continuously variable drive comprising:
a variator having a first plurality of balls, each ball provided with a tiltable axis of rotation, each ball in contact with a first traction ring assembly and a second traction ring assembly, and each ball operably coupled to a carrier assembly;
a first planetary gear set arranged coaxially with the variator, the first planetary gear set having a first ring gear operably coupled to the first traction ring assembly, a first planet carrier operably coupled to an input shaft, and a first sun gear operably coupled to the second traction ring assembly; and
a multiple speed gear box coupled to the second traction ring assembly and the first sun gear, the multiple speed gear box comprising:
a second planetary gear set arranged coaxially with the variator, the second planetary gear set having a second ring gear, a second planet carrier, and a second sun gear;
a third planetary gear set arranged coaxially with the variator, the third planetary gear set having a third ring gear operably coupled to the second planet carrier, a third planet carrier operably coupled to the second ring gear, and a third sun gear;
a forward mode clutch operably coupled to the second traction ring assembly, wherein the forward mode clutch is configured to selectively couple the second traction ring assembly to the third sun gear;
a first-and-reverse mode clutch operably coupled to the third ring gear, the first-and-reverse mode clutch is configured to selectively couple the third ring gear to ground;
a second-and-fourth mode clutch operably coupled to the second sun gear, the second-and-fourth mode clutch configured to selectively couple the second sun gear to ground; and
a third-and-fourth mode clutch operably coupled to the second traction ring assembly, the third-and-fourth mode clutch is configured to selectively couple the second traction ring assembly to the second planet carrier.

2. The continuously variable drive of claim 1, further comprising a reverse mode clutch operably coupled to the second traction ring assembly, the reverse mode clutch configured to selectively couple the second traction ring assembly to the second sun gear.

3. The continuously variable drive of claim 1, further comprising a torque converter coupled to the input shaft.

4. The continuously variable drive of claim 1, further comprising a locking clutch configured to selectively couple the first ring gear and the first planet carrier.
